(19) United States
(12) Patent Application Publication
(10) Pub. No.: US 2010/0192991 A1
(43) Pub. Date: Aug. 5, 2010

(54) Speed Coaching System for Drive-Through Vehicle Wash Tunnel

(75) Inventors: Michael J. BELANGER, Novi, MI (US); Barry S. TURNER, Novi, MI (US); Thomas E. WEYANDT, Northville, MI (US); Curtis S. PRATER, Warren, MI (US)

Correspondence Address: YOUNG BASILE, 3001 WEST BIG BEAVER ROAD, SUITE 624, TROY, MI, 48084, US

(73) Assignee: Belanger, Inc., Northville, MI (US)

(21) Appl. No.: 12/695,259

(22) Filed: Jan. 28, 2010

Related U.S. Application Data
(60) Provisional application No. 61/149,477, filed on Feb. 3, 2009.

(51) Int. Cl. B08B 3/00; G08B 5/22

(52) U.S. Cl. 134/123; 340/815.45

(57) ABSTRACT

A vehicle wash system using a light ribbon running along an adjacent wall to coach vehicle drivers as to the speed they should when transiting a multistation wash system. The light ribbon is made up of one or more rows of LED's and can be operated in any of several modes including multicolored displays as well as a “rabbit” mode. Sensors, timers, and digital processors are used to monitor vehicle location and speed and cause appropriate activation of the lighting system. An event log is maintained.

### RELATED APPLICATION DATA

This application claims priority to U.S. Provisional Patent Application Ser. No. 61/149,477 filed under attorney docket no. BGR-196-A on Feb. 3, 2009, currently pending. The content of the U.S. patent application Ser. No. 61/149,477 is incorporated herein by reference.

### FIELD OF THE INVENTION

This invention relates to vehicle wash equipment and more particularly to a vehicle washing system in which the drivers of vehicles passing through an equipment station or a series of stations are coached by controlled lights to maintain a recommended speed.

### BACKGROUND OF THE INVENTION

In general vehicle wash systems fall into three categories: conveyor wash systems, rollover systems, and fleet systems. In conveyor systems, vehicles such as passenger cars, SUVs, and light trucks, are pushed or pulled through one or more processing stations by a conveyor. Drivers do not control speed and, in some cases, may not be in the vehicle at all during the process. In a rollover or “automatic” system, the vehicle is typically positioned within a bay where it remains stationery while a gantry or overhead carriage carrying spray nozzles, brushes or a combination of these moves over, along, and/or around the vehicle at a controlled speed. In a fleet system, typically used for trucks and busses, an operator drives the vehicle past and/or through the various equipment stations.

In the fleet system where the vehicle is moved under operator control, it is important that the vehicle move along the wash lane within a fairly well-defined speed range. Moving the vehicle too slowly may cut down on productivity or waste water and chemicals, while moving the vehicle too fast may provide inadequate washing or rinsing and/or cause damage to the vehicle and/or to the equipment in the wash system. Stationary lights, often resembling traffic lights or beacons, have been used to provide stop and go commands as well as for control purposes, but they are typically too far apart for precision and often cannot be seen because of equipment blocking the sight line.

### SUMMARY OF THE INVENTION

The present invention provides a lighting system that extends along a wash lane through which vehicles are caused to pass under operator control. The lighting system is illuminated in such a way as to provide easily observed visual effects which coach the driver of a vehicle to maintain a recommended speed as the vehicle passes through a station and/or from station to station through the wash system.

In one embodiment, the lighting system provides a “pacer” function; i.e., a linear lighting element or set of elements extends along or beside the path of travel and is illuminated progressively so as to appear to move along and in parallel to the wash lane at a speed which represents the appropriate speed for the driver to follow. In this embodiment, the driver simply tries to keep pace with the light as it illuminates in a progressive fashion.

In another embodiment hereinafter described, the system comprises one or more sensors located along and/or in the wash lane to sense vehicle location, as well as to determine or calculate vehicle speed. Outputs from the sensor or sensors and/or the associated processing equipment are used to actuate a light strip or ribbon which, in the example hereinafter described, runs along a wall adjacent the wash lane where it can be readily observed by the driver of a vehicle at all times. The light ribbon may have a single color or multiple colors and may be actuated in any or all of a variety of modes to convey speed coaching to the driver.

In accordance with still another aspect of the invention, a usage log, which may be specific as to vehicle, time, and location, is maintained to provide management reports. Such reports may be as simple as recording usage numbers, but may also report over-speed and/or under-speed conditions at specific times. In this way, a system damage event can be traced to a specific vehicle and driver and appropriate measures taken.

### BRIEF DESCRIPTION OF THE DRAWINGS

FIG. 1 is a perspective view of a representative fleet wash system employing one form of the invention; and

FIG. 2 is a schematic circuit diagram of a sensing and processing system for use in connection with the system of FIG. 1.

### DETAILED DESCRIPTION OF AN ILLUSTRATIVE EMBODIMENT

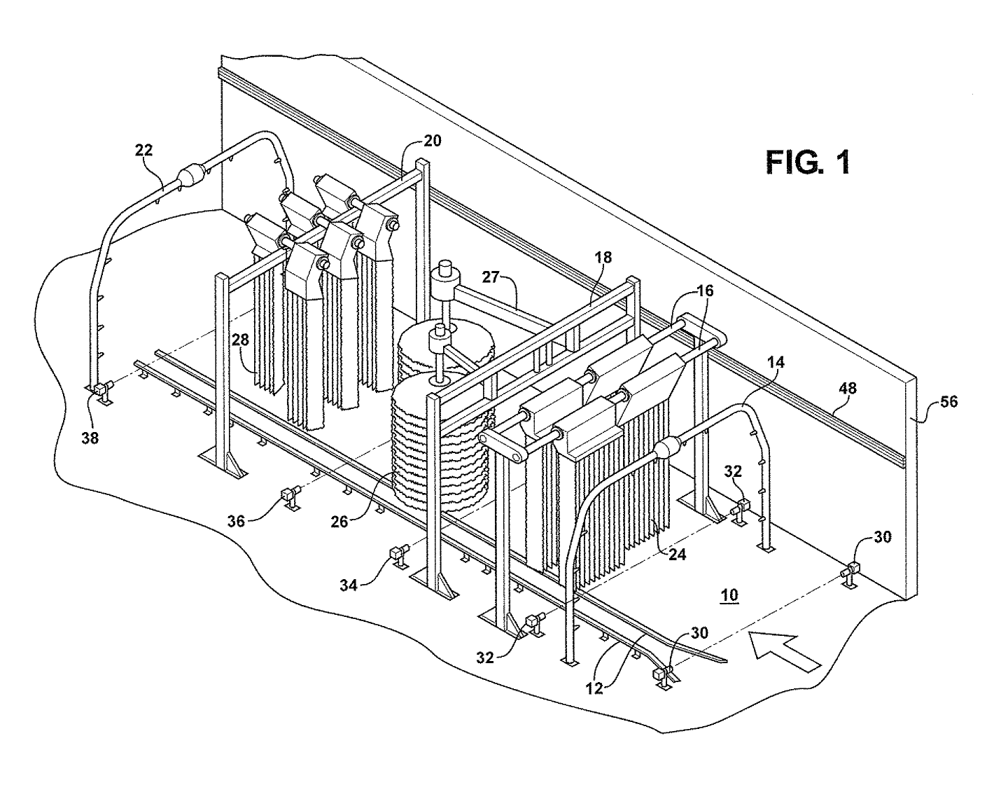

Referring to FIG. 1, there is shown a vehicle wash lane 10 comprising a set of spaced apart parallel vehicle tire guides 12, which are anchored to the floor of the wash lane 10 and run the entire length of the wash lane to guide vehicles through a system or series of stations hereinafter described.

The vehicle wash system comprises a series of structural arches 14, 16, 18, 20, and 22 with vertical structural members which are far enough apart laterally to permit vehicles to pass between them as they traverse the wash lane 10. The arches further comprise cross members or bridges which are high enough to permit the vehicles traversing the wash lane 10 to pass under them.

Arch 14 may provide a prewash water/chemical application; arch 16 includes motor-driven fore and aft swinging Mitter curtains 24; arch 18 carries friction brushes 26 on pivotal arms 27; arch 20 carries a second system of Mitter curtains 28 which are rocked laterally; and arch 22 provides a final spot-free rinse operation. The arches 14, 16, 18, 20, and 22 are spaced at intervals along the wash lane 12 and, while they are representative of a wash system for fleet vehicles, it is to be understood that the spacing of any given system may vary considerably from that illustrated in FIG. 1, and more or less equipment may be used in any given system. For example, additional brushes, sprays, wheel washers, drying blowers, and tire treatment stations may be added with or without overhead arches.

Also positioned along the wash lane 10 are vehicle sensors 30, 32, 34, 36, and 38. In this case the sensors are cross-beam optical sensors with a light source on one side of the wash lane 10 and a light sensor on the opposite side and lined up with the light source to “see” the light when there is no vehicle between the source and the sensor. The arrival of a vehicle at a sensor set immediately before a particular piece of machinery in the system breaks the beam and starts a timing sequence to arm or energize equipment in the station and also function as hereinafter described.

In the FIG. 1 system, vehicle speed is measured station by station along the wash lane by counting clock pulses between the arrival of a vehicle at each of two sequential sensors such as 30 and 32. Again, this is intended to be representative rather than limiting, as many variations in speed sensing, and vehicle location sensing are possible. For example, contact wands with limit switches may be used in place of optical sensors. As another alternative, radar guns may be used to make direct readings of vehicle speed.

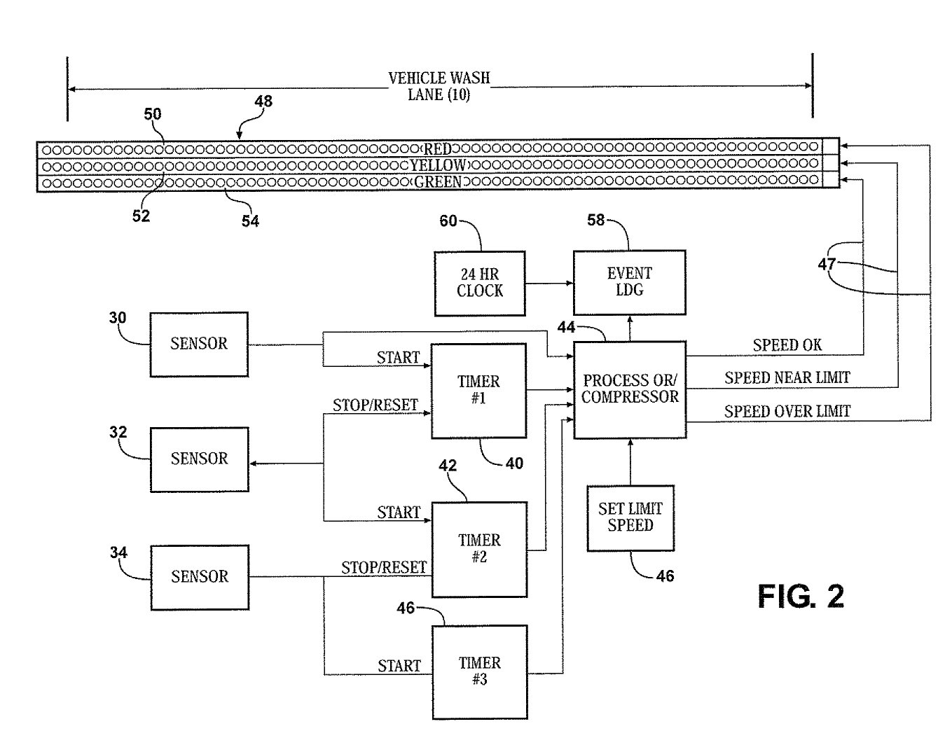

Referring to FIG. 2, sensors 30 and 32 are connected to the “start” and “stop/reset” inputs of a digital timer 40 which counts clock pulses between the start signal and the stop signal so that vehicle speed between the sensors 30 and 32 can be calculated by counting pulses and comparing the count to a fixed standard. A variation or departure from standard may be determined by comparing the pulse count to a standard count and producing an error or difference signal. Sensors 32 and 34 are connected as “start” and “stop/reset” signals to a second timer 42; additional timers 46 are connected to additional sensors in the same fashion to provide a system or chain of timers that measure the time taken for passage of the vehicle between successive sensors associated with the various stations along the wash lane 10. In each case, time is readily correlated with speed.

The outputs of all of the timers 40, 42, 46, and so forth are connected as inputs to a processor 44 which is also connected to receive a recommended or set limit “speed signal” from a source 46. As will be understood by those familiar with digital processing equipment, the unit 46 may actually be unitized or integrated with the processor 44, where that capability is provided by the circuit manufacturer. The processor uses the timer counts to calculate vehicle speed and provide outputs on lines 47 to operate a lighting ribbon 48 which is mounted on a wall 56, which extends along and somewhat past the entire length of the wash lane 10. In this case, the lighting system or ribbon 48 comprises three parallel ribbons 50, 52, and 54, which present red, yellow, and green lighting effects respectively.

The ribbons are preferably made up of a series of high power LED's which are arranged within translucent plastic tubes or carriers which are mounted in, for example, an extruded aluminum carrier (not shown). The LEDs in each ribbon can be about 1¼ to 12 or more inches apart. Color may be provided by the LEDs themselves or by the translucent tubes which house them.

The operation of the system thus far described may, for example, be as follows. As a vehicle approaches the wash lane 10, the driver steers the vehicle such that the left front wheel enters into the space between the tire guides 12 and the sensor 30 signals the processor to turn on all three of the light ribbons 50, 52, and 54 to signal the driver that the presence of the vehicle has been noted and that the wash system is being made ready for use. A camera (not shown) may read a number on the side of the vehicle if appropriate and input a vehicle identification to the processor 44 to place in an event log. The light ribbons 50, 52, and 54 may thereafter be extinguished until the driver begins to progress toward the second sensor 32. When the vehicle reaches the second sensor, a speed signal is produced by the combination of sensors 30 and 32, timer 40 and processor 44. The processor produces an output which turns on one of the three light ribbons 50, 52, and 54 to signal the driver as to whether or not the speed of the vehicle is within the recommended range. A green light caused by activating ribbon 54 tells the driver that he or she is in the appropriate speed range. Activation of the yellow light ribbon 52 tells the driver that he or she may be going slightly too fast and that a moderate speed reduction is needed to keep the vehicle in the recommended speed range. If the vehicle is traveling fast enough to create the risk of damage to the vehicle and/or the equipment in the wash lane 10, the red ribbon 50 is activated to advise the driver to slow down. Flashing or blinking the ribbons may be used to show an underspeed condition.

It can be seen that the driver can observe the light ribbon at all times as the vehicle passes along the wash lane 10; i.e., the light ribbon 48 is seldom if ever obscured by equipment to the point that the driver cannot see it and take advantage of the coaching cues that are provided thereby.

What is described above is only one of several modes of operating a ribbon lighting system. As another example, under-speed conditions can be signaled by causing only the green ribbon in the system 48 to blink or flash. As another example, a separate under-speed ribbon of another color, e.g. blue, can be used to indicate under-speed conditions, As a still further variation, a single color light ribbon 48 may be operated in a “rabbit” or pacer mode wherein the activation of the individual LED's starts at the right end of the ribbon 48 and progresses from right to left as seen in FIG. 2 at the recommended speed to effectively pace the vehicle. This means the driver simply operates the vehicle in such a way as to keep pace with the light or lights and avoid over-speed conditions in which the vehicle gets ahead of the light “rabbit” as it is progressively activated during a vehicle wash function. The rabbit system may use a single color LED strip and work well without the timers and some processor circuitry described above. Vehicle sensors are, of course, retained to sequentially turn equipment on. In the pacer system, the ribbon of light may be cumulative; i.e., LEDs which are turned on remain on so that the ribbon of light continues to grow in length. Alternatively, a block of LEDs may move progressively along while the once-lighted LEDs behind the block go out. As another alternative, blocks of LEDs can be lighted in a serial fashion. The overall effect is to provide a substantially continuous visual effect along the vehicle travel path which a driver can follow. The term “substantially continuous” is included to cover lighting effects with and without gaps.

Returning now to FIG. 2, it can be seen that the output of the processor 44 is also connected to an event log 58 which also receives signals from a 24-hour clock 60. The purpose of the event log is to report each use of the wash system as well as details such as (a) the time of day or night when each vehicle is washed; (b) the speed record for each vehicle; (c) the location of each vehicle being washed at a particular time of day or night; and (d) any unusual event such as damage to a system component associated with particular vehicle passage in an over-speed condition. It is a simple matter to add individual vehicle identification to the event log by way of a camera which reads vehicle numbers and inputs them to the event log or by way of a card reader or keyboard which drivers must use in order to activate the system prior to a washing operation.

The lights of the present invention are substantially or fully continuous along the wash lane; i.e., while they may be segregated into blocks and may be defined by individual light elements such as LEDs or groups of LEDs, they act collectively to define a visual effect which the driver perceives as a strip or ribbon, albeit it may have gaps or move in a progressive fashion.

While the system described above is typically used for fleet operations where the vehicles being washed are, for example, transit busses, it will be understood that this system may also be used for train cars, trucks, and even passenger cars where an operator drive-through function is employed.

What is claimed is:

1. A system for coaching the driver of a vehicle to maintain a predetermined speed when passing through a wash system defining a lane of travel comprising:
a lighting system extending substantially along said lane; and
a control for illuminating the lighting system so as to produce a visual effect related to desired speed of vehicle travel.

2. A system as defined in claim 1 wherein the light comprises at least one series of LEDs.

3. A system as defined in claim 1 wherein the light series consists of multiple LEDs which are illuminated progressively.

4. A system as defined in claim 3 wherein the progressive illumination occurs at a predetermined speed.

5. A system as defined in claim 1 wherein the visual effect is provided by color.

6. A system as defined in claim 1 wherein the control includes one or more sensors positioned along the lane to sense vehicle speed.

7. A system as defined in claim 6 wherein the visual effect includes one or more colors.

8. A vehicle wash system comprising:
a wash lane;
at least one device for treating vehicles located along the wash lane; and
a pacer light running along the lane and illuminated in such a way as to coach a vehicle driver in the lane as to desired speed of travel.
